(19) United States
(12) Patent Application Publication
(10) Pub. No.: US 2011/0166763 A1
(43) Pub. Date: Jul. 7, 2011

(54) Apparatus and method detecting a robot slip

(75) Inventors: Ki-Wan Choi, Anyang-si (KR); Ji-Young Park, Yongin-si (KR); Hyoung-Ki Lee, Seongnam-si (KR); Woo-Yeon Jeong, Seoul (KR)

(73) Assignee: SAMSUNG ELECTRONICS CO., LTD., Suwon-si (KR)

(21) Appl. No.: 12/926,009

(22) Filed: Oct. 20, 2010

(30) Foreign Application Priority Data
Jan. 5, 2010 (KR) 10-2010-0000492

(51) Int. Cl. G05D 1/00

(52) U.S. Cl. 701/82

(57) ABSTRACT

An apparatus and method for detecting a slip of a robot. According to the apparatus and method, the probability of a slip occurring may be preliminarily determined using a first acceleration obtained from an acceleration sensor and a second acceleration obtained from an encoder. Then, finally the occurrence of a slip may be determined using a change in a driving control signal. Thus, accurate detection of a slip can be realized while preventing incorrect determination of slip occurrence.

### CROSS-REFERENCE TO RELATED APPLICATIONS

This application claims the benefit under 35 U.S.C. §119(a) of a Korean Patent Application No. 10-2010-0000492, filed on Jan. 5, 2010, the entire disclosure of which is incorporated herein by reference for all purposes.

### BACKGROUND

1. Field

One or more embodiments relate to a localization technology of a mobile robot.

2. Description of the Related Art

Mobile robots are drawing attention since they can perform any kind of task in extreme environments or dangerous sites in place of humans. Also, home mobile robots such as cleaning robots have come into wide use to assist in chores while autonomously moving around the house.

When the robot autonomously moves to conduct a task, a mobile robot typically requires localization for tracking its current position. A typical example of localization technologies is a simultaneous localization and mapping (SLAM) technique. SLAM refers to a method by which a robot detects information about surroundings and processes the obtained information, thereby estimating the absolute position thereof while building a map corresponding to a task space for task to be performed.

When the robot obtains the information about its surroundings to perform the SLAM, if an unexpected slip occurs during motion of the robot, errors in obtaining information increase resulting in inaccuracies in the position recognition. In particular, when a cleaning robot operates in homes having a complicated structure, the robot may slip while passing over a carpet or a door sill or may collide with an obstacle. The slip represents a state in which a driving wheel rotates but the robot does not move. Thus it is desirable for the slip to be detected and for another path to be generated, thereby preventing the robot from becoming stuck.

One method of detecting a slip is to determine the occurrence of a slip based on a difference between a robot's actual moving distance and an estimated moving distance obtained by a driving wheel encoder. Generally, two methods may be used to calculate the actual moving distance of a mobile robot. One is to use motion of images acquired by an imaging device such as a camera, and another is to use an inertial sensor (e.g., an accelerometer or a gyro sensor) inside the mobile robot. However, since the inertial sensor measures gravity components when the mobile robot is in an inclined position, a slip may be wrongly detected in such situations where a frontal end or a rear end of the mobile robot is slightly tilted while passing over a carpet or a door sill.

### SUMMARY

In one general aspect, provided is an apparatus detecting a slip of a robot, including a driving control unit to generate a driving control signal for controlling a motion of the robot, and a slip detecting unit to determining whether a slip has occurred using a first acceleration acquired by an acceleration sensor, a second acceleration acquired by an encoder, and a determined change in the driving control signal. The driving control signal may be a pulse width modulation (PWM) signal that controls a rotation speed of either a wheel of the robot or a motor for driving the wheel.

The slip detecting unit may include a first determining unit to determine whether a difference between the first acceleration and the second acceleration is equal to or greater than a first threshold, a second determining unit to determine whether the change in the driving control signal is equal to or greater than a second threshold when the difference between the first acceleration and the second acceleration is equal to or greater than the first threshold, and a third determining unit to determine whether a slip index value that indicates a frequency of slip occurrence is equal to or greater than a third threshold when the change in the driving control signal is equal to or greater than the second threshold.

In addition, the slip detecting unit may include a first determining unit to determine whether the change in the driving control unit is equal to or greater than a first threshold, a second determining unit to determine whether a difference between the first acceleration and the second acceleration is equal to or greater than a second threshold when the change in the driving control signal is equal to or greater than the first threshold, and a third determining unit to determine whether a slip index value that indicates a frequency of slip occurrence is equal to or greater than a third threshold when the difference between the first acceleration and the second acceleration is equal to or greater than the second threshold.

In another general aspect, provided is a method detecting a slip of a robot, including determining whether a difference between a first acceleration and a second acceleration is equal to or greater than a first threshold, determining whether a determined change in a driving control signal is equal to or greater than a second threshold when the difference between the first acceleration and the second acceleration is equal to or greater than the first threshold, and increasing a slip index value that indicates a frequency of slip occurrence and determining whether the increased slip index value is equal to or greater than a third threshold when the change in the driving control signal is equal to or greater than the second threshold.

In another general aspect, provided is a method detecting a slip of a robot, including determining whether a determined change in a driving control signal is equal to or greater than a first threshold, determining whether a difference between a first acceleration acquired by an acceleration sensor and a second acceleration acquired by an encoder is equal to or greater than a second threshold when the change in the driving control signal is equal to or greater than the first threshold, and increasing a slip index value that indicates a frequency of slip occurrence and determining whether the increased slip index value is equal to or greater than a third threshold when the difference between the first acceleration and the second acceleration is equal to or greater than the second threshold.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of embodiments, taken in conjunction with the accompanying drawings of which:

FIG. 1 is a diagram illustrating a slip detecting apparatus, according to one or more embodiments;

FIG. 2 is a diagram illustrating a slip detecting unit, according to one or more embodiments;

FIG. 3 is a diagram illustrating another slip detecting unit, according to one or more embodiments; and

FIG. 4 is a flowchart of a slip detecting method, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

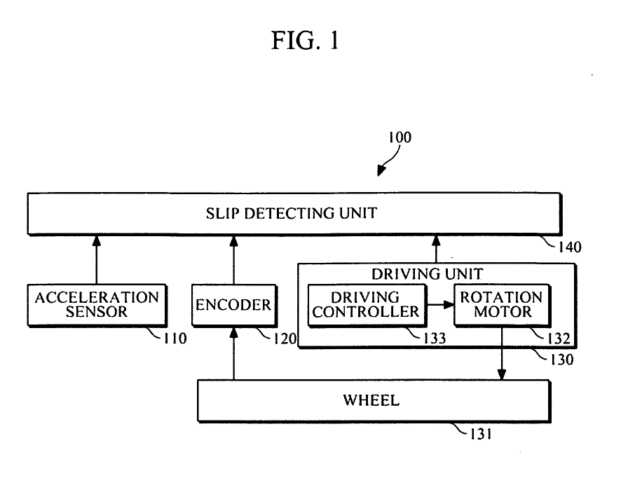

FIG. 1 illustrates a slip detecting apparatus, according to one or more embodiments.

Referring to FIG. 1, a slip detecting apparatus 100 may include an acceleration sensor 110, an encoder 120, a driving unit 130, and a slip detecting unit 140, for example.

The slip detecting apparatus 100 detects the occurrence of a slip of a mobile robot. The mobile robot may be a mobile robot, for example, a home cleaning robot, that conducts a given task while moving around a predetermined space. A slip refers to a state in which a driving wheel 131 of a robot keeps rotating while the robot does not move. A slip usually occurs when a robot is stopped by an obstacle while moving over the obstacle. The slip detecting apparatus 100 may be implemented as a component of a robot.

The acceleration sensor 110 measures a first acceleration of the robot. The first acceleration measured by the acceleration sensor 110 relates to current motion of the robot. The acceleration sensor 110 may be one of a piezoelectric sensor, a vibration sensor, a strain-gauge sensor, an electrodynamic sensor, and a servo-type sensor, for example.

The encoder 120 measures a second acceleration of the robot. The second acceleration measured by the encoder 120 relates to current motion of a wheel 131. It should be noted that the robot may have one, or more than one wheel and that all of these cases fall under the scope of one or more embodiments of the present invention. The encoder 120 may count the number of rotations of the wheel 131, and calculate a moving distance, a velocity, and an acceleration of the robot based on the counted number of rotations with relation to elapsed time.

The driving unit 130 may include a rotation motor 132 and a driving controller 133. The rotation motor 132 provides motion force to the robot and rotates the wheel 131. The driving controller 133 may control a rotation speed of the rotation motor 133. The rotation speed of the rotation motor 133 is controlled according to a driving control signal of the rotation motor 132.

The driving control signal may be a pulse width modulation (PWM) signal, for example. The driving controller 133 may adjust a width of the PWM signal according to the condition of a floor surface of a task space for the robot to conduct a task. For example, the rotation motor 132 may accelerate the rotation speed of the wheel 131 in response to a narrow PWM signal assigned thereto, or slow down the rotation speed in response to a wide PWM signal. Alternatively, the rotation speed of the wheel 131 may be slowed down in response to a narrow PWM signal, and in one or more embodiments various other methods may be used according to the field of application.

The slip detecting unit 140 detects the occurrence of a slip of the robot using the first acceleration from the acceleration sensor 110, the second acceleration from the encoder 120, and a change in the driving control signal provided by the driving controller 133. The change in the driving control signal may be, for example, a change of the width of a PWM signal.

In one example, the slip detecting unit 140 may preliminarily estimate the probability of a slip occurring using the first acceleration and the second acceleration, and finally determine whether the slip has occurred based on the change in the driving control signal.

In another example, the slip detecting unit 140 may preliminarily estimate the probability of a slip occurring based on the change in the driving control signal, and finally determine whether the slip has occurred using the first acceleration and the second acceleration.

In yet another example, the slip detecting unit 140 may preliminarily estimate the probability of a slip occurring using the first acceleration, the second acceleration, and the change in the driving control signal, and finally determine whether the slip has occurred using a predetermined index.

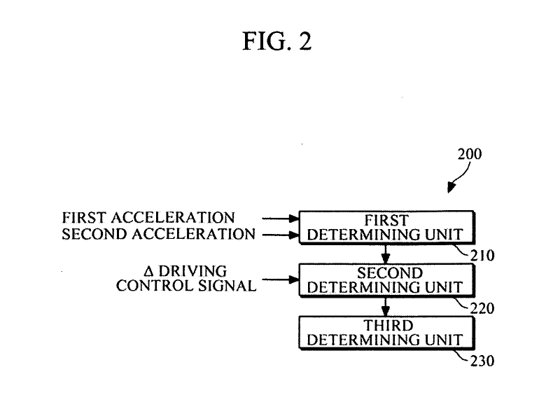

FIG. 2 illustrates a slip detecting unit, according to one or more embodiments.

Referring to FIG. 2, a slip detecting unit 200 may include a first determining unit 210, a second determining unit 220, and a third determining unit 230, for example.

The first determining unit 210 may calculate a difference between a first acceleration and a second acceleration. The first acceleration may be obtained from the acceleration sensor 110 (see FIG. 1), and the second acceleration may be obtained from the encoder 120 (see FIG. 1). A difference between the first acceleration and the second acceleration is compared with a first threshold. If the difference between the first acceleration and the second acceleration is equal to or greater than the first threshold, the first determining unit 210 may preliminarily infer the probability of a slip. The probability may be described according to the below Equation 1, for example.

a_{acc}−aₑₙ≦−thₐ or |a_{acc}−aₑₙ|≧thₐ Equation 1:

Here, a_{acc} is a first acceleration, aₑₙ is a second acceleration, and thₐ is a first threshold.

For example, when a cleaning robot is being impeded by an electric cable in spite of its wheels rotating, the first acceleration is 0 because the cleaning robot is not moving. In addition, since the wheel of the cleaning robot rotates at a constant speed while the cleaning robot is impeded by the electric cable, the second acceleration is also 0. Thus, there is no difference between the first acceleration and the second acceleration, and accordingly it may be determined that no slip has occurred. However, at the moment when the cleaning robot initially trips on the electric cable, the first acceleration abruptly changes while the second acceleration stays the same. As such, when a difference between the first acceleration and the second acceleration goes beyond the first threshold, it may be preliminarily determined that a slip may have occurred.

The second determining unit 220 may compare the change in the driving control signal with a second threshold when the first determining unit 210 has inferred the probability of the slip, that is, when the difference between the first acceleration and the second acceleration is equal to or greater than the first threshold. The change in the driving control signal may be acquired by monitoring a PWM signal of the driving controller 133. If the comparison result shows that the change in the driving control signal is equal to or greater than the second threshold, a final determination may be made that the slip has occurred. The determination may be made according to the below Equation 2, for example.

Δpwm>th_{b} Equation 2:

Here, Δpwm is a change in a driving control signal, and th_{b} is a second threshold.

Alternatively, the second determining unit 220 may further preliminarily infer the probability of the slip without making the final determination when the change in the driving control signal is equal to or greater than the second threshold, and issue a predetermined control instruction to the third determining unit 230. The third determining unit 230 may increase a slip index value that indicates the frequency of slip occurrence and finally determines whether a slip has occurred in response to the applied control instruction.

The third determining unit 230 may increase a predetermined slip index value when the second determining unit 220 has inferred the probability of a slip, that is, when the difference between the first acceleration and the second acceleration is equal to or greater than the first threshold and the change in the driving control signal is equal to or greater than the second threshold. The threshold index value may be a reference value for the frequency or probability of slip occurrence.

For example, when a slip index value is 0 in a normal state, the difference between the first acceleration and the second acceleration is equal to or greater than the first threshold and the change in the driving control signal is equal to or greater than the second threshold, and the third determining unit 230 may increase the slip index value to 10 to 100 according to the control instruction of the second determining unit 220.

The slip index value may be increased according to the difference between the first acceleration and the second acceleration and/or the change in the driving control signal.

The third determining unit 230 may compare the increased slip index value with a third threshold. If the comparison result shows that the increased slip index value is equal to or greater than the third threshold, the third determining unit 230 finally determines the occurrence of the slip.

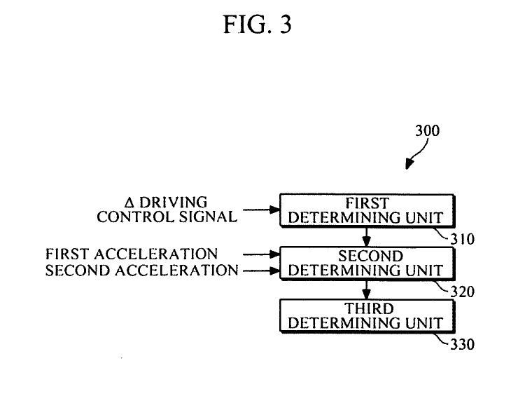

FIG. 3 illustrates another slip detecting unit, according to one or more embodiments. Referring to FIG. 3, a slip detecting unit 300 may include a first determining unit 310, a second determining unit 320, and a third determining unit 330, for example.

The first determining unit 310 may primarily determine the probability of a slip occurring using a change in a driving control signal. For example, the first determining unit 310 may compare a change in a PWM signal from the driving controller 133 (see FIG. 1) with a first threshold, and primarily determine that the slip has possibly occurred when the first change in the PWM signal is equal to or greater than the first threshold.

The second determining unit 320 may secondarily determine the probability of a slip occurring using a first acceleration and a second acceleration under the control of the first determining unit 310. For example, the second determining unit 320 may compare a second threshold with a difference between the first acceleration and the second acceleration, and secondarily determine that the slip has possibly occurred when the difference is equal to or greater than the second threshold.

The third determining unit 330 may finally determine whether the slip has occurred using a slip index value under the control of the second determining unit 320. For example, the third determining unit 330 may increase the slip index value and compare the increased slip index value with a third threshold. If the slip index value is equal to or greater than the third threshold, the third determining unit 330 finally determines that the slip has occurred.

In the embodiments illustrated in FIGS. 2 and 3, the determination of the occurrence of a slip of the robot may be made in two steps: preliminary determination and final determination. The preliminary determination may be further divided into a first preliminary determination and a second preliminary determination. The preliminary determination may be performed based on a difference between accelerations and a change in a driving control signal, and the final determination may be performed based on a slip index value.

In addition, the embodiments illustrated in FIGS. 2 and 3 may be implemented without the third determining units 230 and 330. In other words, without use of the slip index value, such that the occurrence of a slip may be determined even when a difference between the first acceleration and the second acceleration is equal to or greater than a predetermined threshold and at the same time the change in a driving control signal is equal to or greater than a given threshold.

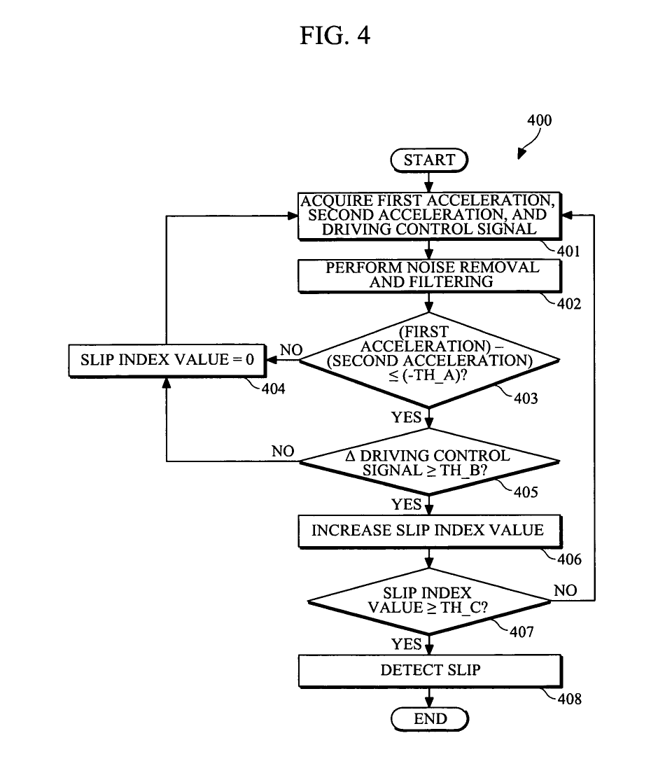

FIG. 4 illustrates a flowchart of a slip detecting method, according to one or more embodiments. Referring to FIG. 4, in a slip detecting method 400, a first acceleration, a second acceleration, and a driving control signal are first acquired (401). The first acceleration may be an acceleration of a robot measured by the acceleration sensor 110 (see FIG. 1). The second acceleration may be an acceleration of the robot calculated based on the number of rotations of the wheel 131 that is measured by the encoder 120. The driving control signal may be a PWM signal to be assigned to the rotation motor 132 that drives the wheel 131 of the robot.

The acquired first acceleration, second acceleration and driving control signal may be filtered and noise removal may be performed (402).

Then, it is determined whether a difference between the first acceleration and the second acceleration is equal to or greater than a first threshold (403), such as the illustrated TH_A. For example, the first determining unit 210 (see FIG. 2) may primarily infer the probability of a slip occurring using Equation 1.

When the difference between the first acceleration and the second acceleration is smaller than the first threshold, a slip index value is set to 0 (404). The slip index value may be a reference value for the frequency of slip occurrence. For example, it may be considered that the probability of slip occurrence increases as the slip index value increases.

When the difference between the first acceleration and the second acceleration is equal to or greater than the first threshold, the change in the driving control signal is calculated, and it is determined whether the change in the driving control signal is equal to or greater than a second threshold (405), such as the illustrated TH_B. For example, the second determining unit 220 (see FIG. 2) may secondarily estimate the probability of a slip occurring using Equation 2.

When the difference between the first acceleration and the second acceleration is equal to or greater than the first threshold and the change in the driving control signal is equal to or greater than the second threshold, the slip index value is increased (406). For example, the third determining unit 230 (see FIG. 2) may adjust the slip index value using the difference between the first acceleration and the second acceleration and/or the change in the driving control signal.

Thereafter, the slip index value is compared with a third threshold, such as the illustrated TH_C, to determine whether the slip index value is equal to or greater than the third threshold (407). For example, the third determining unit 230 (see FIG. 2) may compare the increased slip index value with the third threshold.

When the slip index value is equal to or greater than the third threshold, it may be finally determined that a slip has occurred and the slip is detected (408).

In one example, if the difference between the first acceleration and the second acceleration is equal to or greater than the first threshold and the change in the driving control signal is equal to or greater than the second threshold, operation 408 may be directly performed without performing operations 406 and 407. That is, if the difference between the first acceleration and the second acceleration is equal to or greater than the first threshold and the change in the driving control signal is equal to or greater than the second threshold, it may be immediately determined that the slip has occurred.

In another embodiment, the order of performing the operations 403 and 405 may be reversed. That is, the determination of the probability of slip occurrence based on the change in the driving control signal may be performed first, and then the determination of the probability of slip occurrence based on the acceleration difference may be made later.

In one or more embodiments, apparatus, system, and unit descriptions herein include one or more hardware processing elements. For example, each described unit may include one or more processing elements performing the described operation, desirable memory, and any desired hardware input/output transmission devices. Further, the term apparatus should be considered synonymous with elements of a physical system, not limited to a single enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be a distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), which executes (processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. An apparatus detecting a slip of a robot, comprising:
a driving control unit to generate a driving control signal for controlling a motion of the robot; and
a slip detecting unit to determining whether a slip has occurred using a first acceleration acquired by an acceleration sensor, a second acceleration acquired by an encoder, and a determined change in the driving control signal.

2. The apparatus of claim 1, wherein the driving control signal is a pulse width modulation (PWM) signal that controls a rotation speed of either a wheel of the robot or a motor for driving the wheel.

3. The apparatus of claim 1, wherein the slip detecting unit includes
a first determining unit to determine whether a difference between the first acceleration and the second acceleration is equal to or greater than a first threshold, and
a second determining unit to determine whether the change in the driving control signal is equal to or greater than a second threshold when the difference between the first acceleration and the second acceleration is equal to or greater than the first threshold.

4. The apparatus of claim 3, wherein the slip detecting unit further includes a third determining unit to determine whether a slip index value that indicates a frequency of slip occurrence is equal to or greater than a third threshold when the change in the driving control signal is equal to or greater than the second threshold.

5. The apparatus of claim 4, wherein the third determining unit increases the slip index value when the change in the driving control signal is equal to or greater than the second threshold.

6. The apparatus of claim 1, wherein the slip detecting unit includes
a first determining unit to determine whether the change in the driving control unit is equal to or greater than a first threshold, and
a second determining unit to determine whether a difference between the first acceleration and the second acceleration is equal to or greater than a second threshold when the change in the driving control signal is equal to or greater than the first threshold.

7. The apparatus of claim 6, wherein the slip detecting unit further includes a third determining unit to determine whether a slip index value that indicates a frequency of slip occurrence is equal to or greater than a third threshold when the difference between the first acceleration and the second acceleration is equal to or greater than the second threshold.

8. The apparatus of claim 7, wherein the third determining unit increases the slip index value when the difference between the first acceleration and the second acceleration is equal to or greater than the second threshold.

9. A method detecting a slip of a robot, comprising:
determining whether a difference between a first acceleration and a second acceleration is equal to or greater than a first threshold;
determining whether a determined change in a driving control signal is equal to or greater than a second threshold when the difference between the first acceleration and the second acceleration is equal to or greater than the first threshold; and
increasing a slip index value that indicates a frequency of slip occurrence and determining whether the increased slip index value is equal to or greater than a third threshold when the change in the driving control signal is equal to or greater than the second threshold.

10. The method of claim 9, further comprising:
determining that a slip has occurred when the increased slip index value is equal to or greater than the third threshold.

11. The method of claim 9, wherein the driving control signal is a pulse width modulation (PWM) signal that controls a rotation speed of a motor for driving a wheel of the robot.

12. A method detecting a slip of a robot, comprising:
determining whether a determined change in a driving control signal is equal to or greater than a first threshold;
determining whether a difference between a first acceleration acquired by an acceleration sensor and a second acceleration acquired by an encoder is equal to or greater than a second threshold when the change in the driving control signal is equal to or greater than the first threshold; and
increasing a slip index value that indicates a frequency of slip occurrence and determining whether the increased slip index value is equal to or greater than a third threshold when the difference between the first acceleration and the second acceleration is equal to or greater than the second threshold.

13. The method of claim 12, further comprising:
determining that a slip has occurred when the increased slip index value is equal to or greater than the third threshold.

14. The method of claim 12, wherein the driving control signal is a pulse width modulation (PWM) signal that controls a rotation speed of a motor for driving a wheel of the robot.
